(19) United States
(12) Patent Application Publication
(10) Pub. No.: US 2021/0158391 A1
(43) Pub. Date: May 27, 2021

(54) METHODS, SYSTEMS AND APPARATUS TO ESTIMATE CENSUS-LEVEL AUDIENCE SIZE AND TOTAL IMPRESSION DURATIONS ACROSS DEMOGRAPHICS

(71) Applicant: The Nielsen Company (US), LLC, New York, NY (US)

(72) Inventors: Michael Sheppard, Holland, MI (US); Ludo Daemen, Duffel (BE); Edward Murphy, North Stonington, CT (US); Beate Sissenich, New York, NY (US); Edmond Wong, New York, NY (US); Jing Liu, Jersey City, NJ (US)

(21) Appl. No.: 16/698,180

(22) Filed: Nov. 27, 2019

(51) Int. Cl. G06Q 30/02; G06F 16/23; H04N 21/258; H04N 21/24

(52) U.S. Cl. CPC G06Q 30/0246; G06Q 30/0272; H04N 21/24; G06F 16/2379; H04N 21/25883; G06Q 30/0269

(57) ABSTRACT

Methods, apparatus, and systems are disclosed for determining census-level audience metrics across demographics. An example apparatus disclosed herein includes a distribution parameter solver to initialize distribution parameter values for a probability of an individual within a demographic being included in a subscriber audience for the demographic and having a first average impression duration, the subscriber audience having a first subscriber audience size, a divergence parameter solver to determine divergence parameter values between (i) the subscriber audience size and the first impression duration and (ii) a census-level audience size and a second impression duration based on the initialized distribution parameter values, and a search space identifier to identify a search space within bounds based on a census-level total impression count and a census-level total impression duration, the search space to define a range including an equality constraint.

### FIELD OF THE DISCLOSURE

This disclosure relates generally to computer processing, and, more particularly, to methods, systems, and apparatus to estimate census-level audience size and total impression durations across demographics.

### BACKGROUND

Media content is accessible to users through a variety of platforms. For example, media content can be viewed on television sets, via the Internet, on mobile devices, in-home or out-of-home, live or time-shifted, etc. Understanding consumer-based engagement with media within and across a variety of platforms (e.g., television, online, mobile, and emerging) allows content providers and website developers to increase user engagement with their media content.

### BRIEF DESCRIPTION OF THE DRAWINGS

FIG. 1 is a block diagram illustrating an example operating environment, constructed in accordance with teachings of this disclosure, in which an audience metrics estimator is implemented to determine census-level audience and durations across demographics.

FIG. 2 is a block diagram of an example implementation of the audience metrics estimator of FIG. 1.

FIG. 3 is a flowchart representative of machine readable instructions which may be executed to implement elements of the example audience metrics estimator of FIGS. 1-2.

FIG. 4 is a flowchart representative of machine readable instructions which may be executed to implement elements of the example audience metrics estimator of FIGS. 1-2, the flowchart representative of instructions used to generate probability distributions.

FIG. 5 is a flowchart representative of machine readable instructions which may be executed to implement elements of the example audience metrics estimator of FIGS. 1-2, the flowchart representative of instructions used to determine probability divergences.

FIG. 6 is a flowchart representative of machine readable instructions which may be executed to implement elements of the example audience metrics estimator of FIGS. 1-2, the flowchart representative of instructions used to evaluate probability divergence parameters of FIG. 5.

FIGS. 7A-7C include example programming code representative of machine readable instructions that may be executed to implement the example audience metrics estimator of FIGS. 1-2 to estimate census-level unique audience size and census-level durations across multiple demographics based on third-party subscriber data and census-level data total durations.

FIGS. 8A-8C include example data sets providing third-party subscriber and census-level data, including total duration data used by the example audience metrics estimator of FIGS. 1-2 to generate census-level estimations of unique audience and total impression durations across demographics.

FIG. 9 is a block diagram of an example processing platform structured to execute the instructions of FIGS. 3-6 to implement the example audience metrics estimator of FIGS. 1-2.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Audience measurement entities (AMEs) perform measurements to determine the number of people (e.g., an audience) who engage in viewing television, listening to radio stations, or browsing websites. Given that companies and/or individuals producing content and/or advertisements want to understand the reach and effectiveness of their content, it is useful to identify such information. To achieve this, companies such as The Nielsen Company, LLC (US), LLC utilize on-device meters (ODMS) to monitor usage of cellphones, tablets (e.g., iPads™) and/or other computing devices (e.g., PDAs, laptop computers, etc.) of individuals who volunteer to be part of a panel (e.g., panelists). Panelists are users who have provided demographic information at the time of registration into a panel, allowing their demographic information to be linked to the media they choose to listen to or view. As a result, the panelists (e.g., the audience) represent a statistically significant sample of the large population (e.g., the census) of media consumers, allowing broadcasting companies and advertisers to better understand who is utilizing their media content and maximize revenue potential.

An on-device meter (ODM) can be implemented by software that collects data of interest concerning usage of the monitored device. The ODM can collect data indicating media access activities (e.g., website names, dates/times of access, page views, duration of access, clickstream data and/or other media identifying information (e.g., webpage content, advertisements, etc.)) to which a panelist is exposed. This data is uploaded, periodically or aperiodically, to a data collection facility (e.g., the audience measurement entity server). Given that a panelist submits their demographic data when registering with an AME, ODM data is advantageous in that it links this demographic information and the activity data collected by the ODM. Such monitoring activities are performed by tagging Internet media to be tracked with monitoring instructions, such as based on examples disclosed in Blumenau, U.S. Pat. No. 6,108,637, which is hereby incorporated herein by reference in its entirety. Monitoring instructions form a media impression request that prompts monitoring data to be sent from the ODM client to a monitoring entity (e.g., an AME such as The Nielsen Company, LLC) for purposes of compiling accurate usage statistics. Impression requests are executed whenever a user accesses media (e.g., from a server, from a cache). When a media user is also a part of the AME's panel (e.g., a panelist), the AME is able to match panelist demographics (e.g., age, occupation, etc.) to the panelist's media usage data (e.g., user-based impression counts, user-based total impression durations). As used herein, an impression is defined to be an event in which a home or individual accesses and/or is exposed to media (e.g., an advertisement, content in the form of a page view or a video view, a group of advertisements and/or a collection of content, etc.).

Database proprietors operating on the Internet (e.g., Facebook, Google, YouTube, etc.) provide services (e.g., social networking, streaming media, etc.) to registered subscribers. By setting cookies and/or other device/user identifiers, database proprietors can recognize their subscribers when the subscribers use the designated services. Examples disclosed in Mainak et al., U.S. Pat. No. 8,370,489, which is incorporated herein in its entirety, permit AMEs to partner with database proprietors to collect more extensive Internet usage data by sending an impression request to a database proprietor after receiving an initial impression request from a user (e.g., as a result of viewing an advertisement). Since the user may be a non-panelist (e.g., not a member of an AME panel with available associated demographics data), the AME can obtain data from the database proprietor corresponding to subscribers, given that the database proprietor logs/records a database proprietor demographic impression for the user if the given user is a subscriber. However, to protect the privacy of their subscribers, database proprietors generalize subscriber-level audience metrics by aggregating data. The AME therefore has access to third-party aggregate subscriber-based audience metrics where impression counts and unique audience sizes are reported by demographic category (e.g., females 15-20, males 15-20, females 21-26, males 21-26, etc.).

As used herein, a unique audience size is based on audience members distinguishable from one another, such that a single audience member/subscriber exposed a multiple number of times to the same media is identified as a single unique audience member. As used herein, a universe audience (e.g., a total audience) for media is a total number of persons that accessed the media in a particular geographic scope of interest and/or during a time of interest relating to media audience metrics. Determining if a larger unique audience is reached by certain media (e.g., an advertisement) can be used to identify if an AME client (e.g., an advertiser) is reaching a larger audience base. When an AME logs an impression for access to media by a user not associated with any demographic information, the logged impression counts as a census-level impression. As such, multiple census-level impressions can be logged for the same user since the user is not identified as a unique audience member. Estimation of census-level unique audience, impression counts (e.g., number of times a webpage has been viewed), and durations for individual demographics can increase the accuracy of usage statistics provided by monitoring entities such as AMEs. In examples disclosed herein, the term duration corresponds to an aggregate or total of the individual exposure times associated with impressions during a monitoring interval. For example, the aggregation or total can be at the individual level such that a duration is associated with an individual, the aggregation or total can be at the demographic level such that the duration is associated with a given demographic, the aggregation or total can be at the population level such that the duration is associated with a given population universe, etc. In examples disclosed herein, the duration of audience exposure for an individual may be logged over a measurement interval, but the actual number of impressions themselves may be unknown, given that an individual can watch, for example, between 20 to 30 minutes of different videos during a measurement interval, but the number of individual videos (total impressions) watched during the measurement interval is unknown.

In some examples, for census-level information, an AME has access to the total impression counts (e.g., total number of times a webpage was viewed) and total duration of impressions (e.g., length of time the webpage was viewed), but not the total unique audience (e.g., total number of distinguishable users). The AME can receive additional third-party data limited to users who subscribe to services provided by the third-party, for example, a database proprietor. For example, whereas census-level data includes total census-level impression duration(s) for individuals whose demographic information may not be available, the third-party level data includes subscriber-level data for audience size and durations (e.g., user-based impression duration(s)) that are tied to particular demographics (e.g., demographic-level data). As such, third-party data can provide the AME with partial audience and duration information down to an aggregate demographic level based on matching of subscriber data to different demographic categories performed by the database proprietor providing the third-party data. However, in the interest of subscriber privacy, third-party data does not provide audience and durations tied to a particular subscriber. Example methods, systems and apparatus disclosed herein allow estimation of census-level audience size and durations across different demographic categories based on third-party subscriber data that provides audience size and durations across the different demographic categories for a subset of the population universe.

Examples disclosed herein use one variable (e.g., durations in the census-level and subscriber-based database) that is solved independent of the actual number of available demographics. Examples disclosed herein utilize third-party subscriber-level audience metrics that provide partial information on durations and unique audience size to overcome the anonymity of census-level impressions when estimating total unique audience sizes for media. Examples disclosed herein apply information theory to derive a solution to parse census-level information into demographics-based data. In examples disclosed herein, a census-level audience metrics estimator determines census-level unique audience and durations across demographics by determining probabilities of an individual in a given demographic being a member of the third-party subscriber data for each of the audience size and durations, determining a probability divergence between the third-party subscriber data and census-level data, and establishing a search space within bounds based on an equality constraint that is defined by the summation of the census-level durations for each demographic being equal to the total reference census-level durations. The examples disclosed herein permit estimations that are logically consistent with all constraints, scale independence and invariance.

While examples disclosed herein are described in connection with website media exposure monitoring, disclosed techniques may also be used in connection with monitoring of other types of media exposure not limited to websites. Examples disclosed herein may be used to monitor for media impressions of any one or more media types (e.g., video, audio, a webpage, an image, text, etc.). Furthermore, examples disclosed herein can be used for applications other than audience monitoring (e.g., determining population size, number of attendees, number of observations, etc.). While the disclosed examples include data sets pertaining to impression counts and/or audiences, the data sets can also include data derived from other sources (e.g., monetary transactions, medical data, etc.).

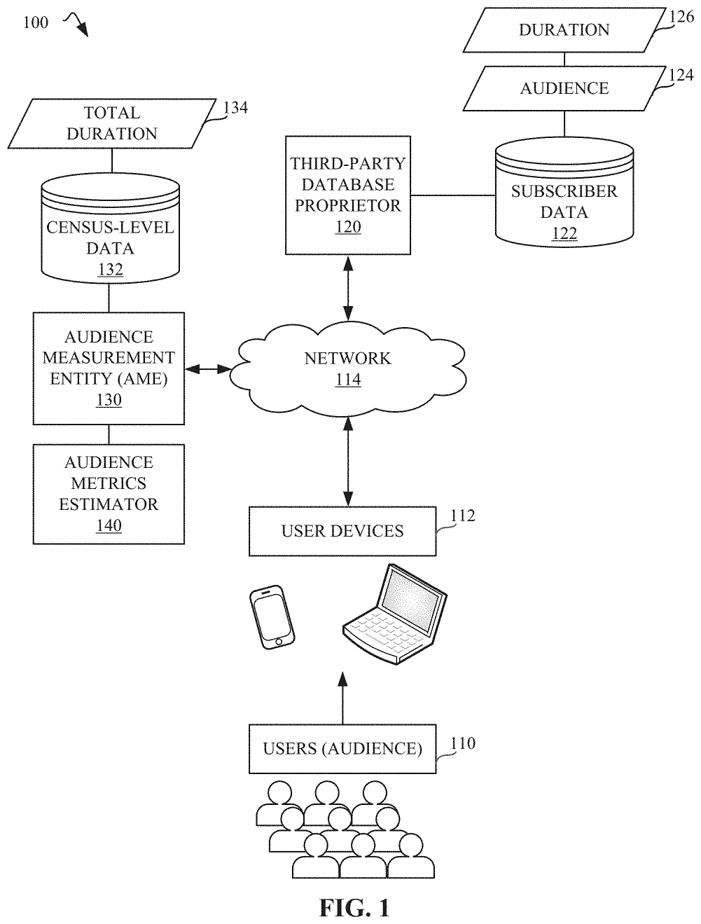

FIG. 1 is a block diagram illustrating an example operating environment 100 in which an audience metrics estimator is implemented to determine census-level audience size and durations across demographics. The example operating environment 100 of FIG. 1 includes example users 110 (e.g., an audience), example user devices 112, an example network 114, an example third-party database proprietor 120, and an example audience measurement entity (AME) 130. The third-party database proprietor 120 includes an example subscriber database 122. The subscriber database 122 includes example subscriber audience size data 124, and example duration data 126. The AME 130 includes example census-level data 132 and an example audience metrics estimator 140. The census-level data 132 includes example total duration 134.

Users 110 include any individuals who access media on one or more user device(s) 112, such that the occurrence of access and/or exposure to media creates a media impression (e.g., viewing of an advertisement, a movie, a web page banner, a webpage, etc.). The example users 110 can include panelists that have provided their demographic information when registering with the example AME 130. When the example users 110 who are panelists utilize example user devices 112 to access media content through the example network 114, the AME 130 (e.g., AME servers) stores panelist activity data associated with their demographic information. The users 110 also include individuals who are not panelists (e.g., not registered with the AME 130). The users 110 include individuals who are subscribers to services provided by the database proprietor 120 and utilize these services via their user device(s) 112.

User devices 112 can be stationary or portable computers, handheld computing devices, smart phones, Internet appliances, and/or any other type of device that may be connected to a network (e.g., the Internet) and capable of presenting media. In the illustrated example of FIG. 1, the client device(s) 102 include a smartphone (e.g., an Apple® iPhone®, a Motorola™ Moto X™, a Nexus 5, an Android™ platform device, etc.) and a laptop computer. However, any other type(s) of device(s) may additionally or alternatively be used such as, for example, a tablet (e.g., an Apple® iPad™, a Motorola™ Xoom™, etc.), a desktop computer, a camera, an Internet compatible television, a smart TV, etc. The user device(s) 112 of FIG. 1 are used to access (e.g., request, receive, render and/or present) online media provided, for example, by a web server. For example, users 110 can execute a web browser on the user device(s) 112 to request streaming media (e.g., via an HTTP request) from a media hosting server. The web server can be any web browser used to provide media content (e.g., YouTube) that is accessed, through the example network 114, by the example users 110 on example user device(s) 112. Network 114 may be implemented using any suitable wired and/or wireless network(s) including, for example, one or more data buses, one or more Local Area Networks (LANs), one or more wireless LANs, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events.

In some examples, media (also referred to as a media item) is tagged or encoded to include monitoring or tag instructions. The monitoring instructions are computer executable instructions (e.g., Java or any other computer language or script) executed by web browsers accessing media content (e.g., via network 114). Execution of monitoring instructions causes the web browser to send an impression request to the servers of the AME 130 and/or the database proprietor 120. Demographic impressions are logged by the database proprietor 120 when user devices 112 accessing media are identified as belonging to registered subscribers to database proprietor 120 services. The database proprietor 120 stores data generated for registered subscribers in the subscriber data storage 122. Likewise, the AME 130 logs census-level media impressions (e.g., census-level impressions) for user devices 112, regardless of whether demographic information is available for such logged impressions. The AME 130 stores census-level data information in the census-level data storage 132. Further examples of monitoring instructions and methods of collecting impression data are disclosed in U.S. Pat. No. 8,370,489 entitled “Methods and Apparatus to Determine Impressions using Distributed Demographic Information,” U.S. Pat. No. 8,930,701 entitled “Methods and Apparatus to Collect Distributed User Information for Media Impressions and Search Terms,” and U.S. Pat. No. 9,237,138 entitled “Methods and Apparatus to Collect Distributed User Information for Media Impressions and Search Terms,” all of which are hereby incorporated herein by reference in their entireties.

The AME 130 operates as an independent party to measure and/or verify audience measurement information relating to media accessed by subscribers of the database proprietor 120. When media is accessed by users 112, the AME 130 stores census-level information in the census-level data storage 132, including total durations 134 (e.g., length of time that a webpage was viewed). The third-party database proprietor 120 provides the AME 130 with aggregate subscriber data that obfuscates the person-specific data, such that reference aggregates among the individuals within a demographic are available (e.g., third-party aggregate subscriber-based audience metrics). For example, the subscriber audience data 124 and durations data 126 are provided at a specific demographic level (e.g., females 15-20, males 15-20, females 21-26, males 21-26, etc.). For example, the subscriber audience data 124 corresponds to unique audience size data in the aggregate per demographic category.

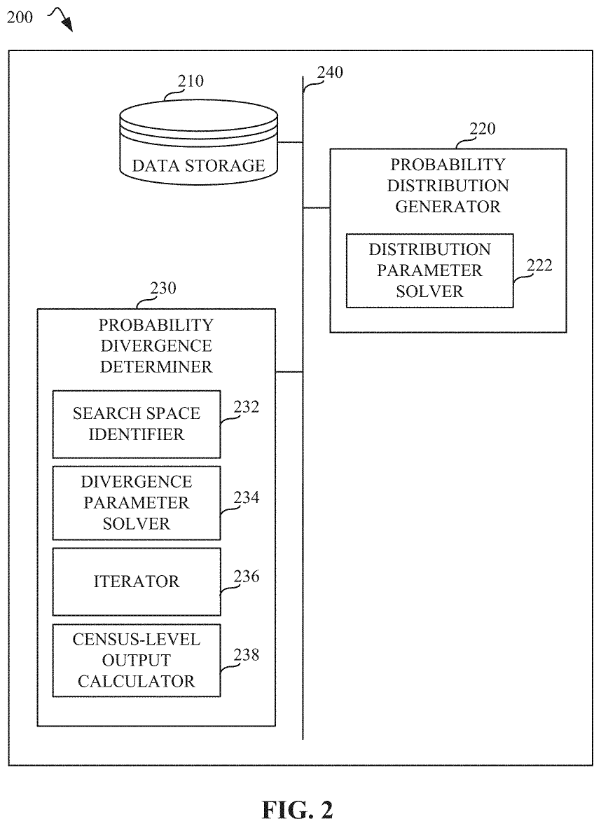

The audience metrics estimator 140 of the AME 130 receives third-party aggregate subscriber-based audience metrics data (e.g., audience size data 124 and duration data 126). The audience metrics estimator 140 uses the aggregate data to estimate census-level audience size data and census-level durations data. In addition, the audience metrics estimator 140 uses the census-level data available to the AME 130 (e.g., total durations 134) to make the census-level audience size and duration estimates for the subscriber-based data, as further described below in connection with FIG. 2.

FIG. 2 is a block diagram of an example implementation of the audience metrics estimator 140 of FIG. 1. The example audience metrics estimator 140 includes example data storage 210, an example probability distribution generator 220, and an example probability divergence determiner 230, all of which are connected using an example bus 240. The probability distribution generator 220 includes an example distribution parameter solver 222. The probability divergence determiner 230 includes an example search space identifier 232, an example divergence parameter solver 234, an example iterator 236, and an example census-level output calculator 238.

The data storage 210 stores third-party aggregate subscriber-based audience metrics data retrieved from the third-party database proprietor 120. For example, data retrieved from the third-party database proprietor 120 and stored in the data storage 210 can include subscriber data 122 (e.g., third-party audience size 124 and third-party duration 126). The data storage 210 can also store census-level data 132 (e.g., total durations 134). The audience metrics estimator 140 can retrieve the third-party and census-level data from the data storage 210 to perform census-level estimation calculations (e.g., determine census-level unique audience size and census-level durations for a given demographic). The data storage 210 may be implemented by any storage device and/or storage disc for storing data such as, for example, flash memory, magnetic media, optical media, etc. Furthermore, the data stored in the data storage 210 may be in any data format such as, for example, binary data, comma delimited data, tab delimited data, structured query language (SQL) structures, etc. While in the illustrated example the data storage 210 is illustrated as a single database, the data storage 210 can be implemented by any number and/or type(s) of databases.

The probability distribution generator 220 generates an estimate of the probability distribution for any individual within a given population, such that the distribution is subject to a probability of the individual being in the audience and having an average duration.

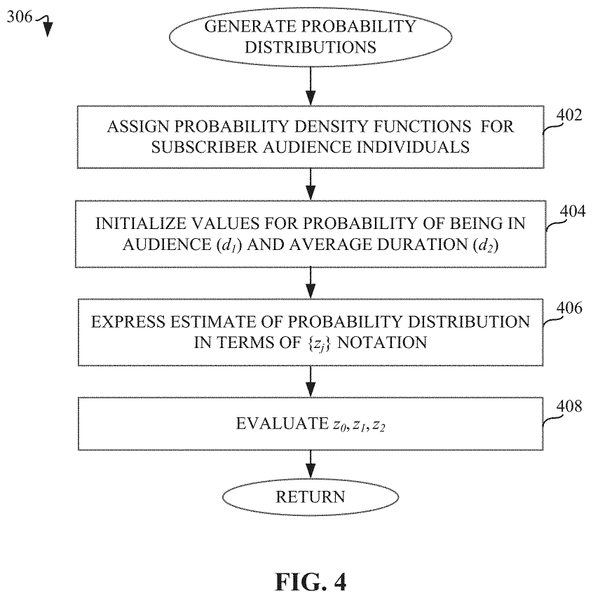

The distribution parameter solver 222 solves for parameters associated with the probability distributions for each individual of a given population. For example, the probability distribution generator 220 assigns probability density functions and/or person-specific probability distributions to third-party subscriber-based audience individuals. In some examples, probability density functions are assigned to subscriber audience individuals using data for third-party subscriber durations 126. In some examples, the probability distribution generator 220 assigns a probability of viewership occurring in the neighborhood of a set time interval (e.g., t₁<t<t₂). In some examples, the probability distribution generator 220 also assigns person-specific probability distributions for individuals within a demographic (k) based on the probability of the individual being in an audience and having average duration. Once the probability distributions have been assigned, the distribution parameter solver 222 determines the solution for the probability distribution such that the final solution can be expressed analytically, as described in more detail in association with FIG. 4.

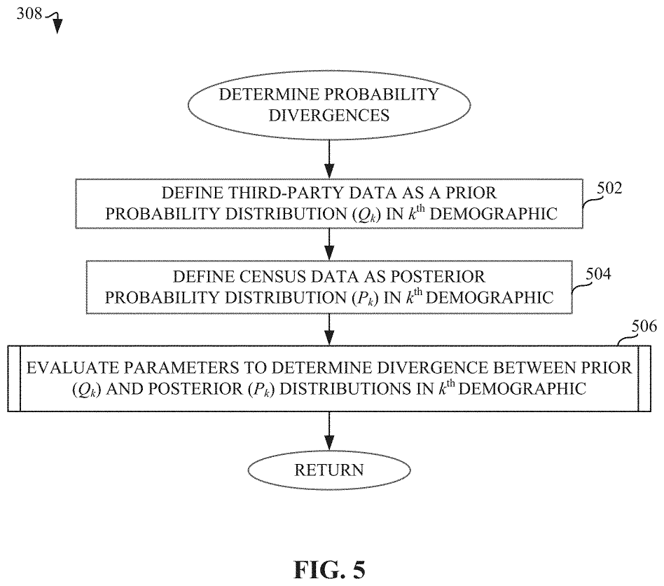

The probability divergence determiner 230 can be used to determine probability divergences between prior and posterior distributions in a given demographic using available third-party subscriber data 122 and census-level data 132 of FIG. 1. For example, the probability divergence determiner 230 can define third-party data as a prior probability distribution in the k^{th} demographic and define the census-level data as a posterior probability distribution in the k^{th} demographic, as described in more detail below in association with FIG. 5. In some examples, the probability divergence can be determined using a Kullback-Leibler (KL) divergence between the two distributions.

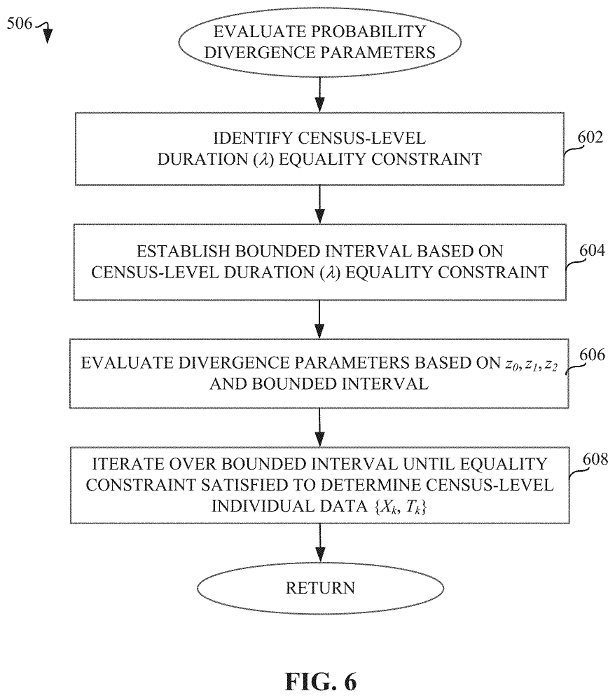

To yield the solutions to census-level audience and durations for different demographic categories based on the probability divergence, the probability divergence determiner 230 uses the search space identifier 232 to establish a search space within a given set of bounds based on a census-level duration equality constraint. For example, once the equality constraint is established, the divergence parameter solver 234 can evaluate the divergence parameters based on the equality constraint. In some examples, the divergence parameter solver 234 uses the iterator 236 to iterate over a search space determined by the search space identifier 232 until the equality constraint is satisfied (e.g., the equality constraint defined by the summation of the census-level duration for each demographic being equal to the total reference census-level duration). The census-level output calculator 238 estimates census-level individual data (e.g., audience and duration), based on solutions that satisfy the equality constraint, as described in more detail in association with FIG. 6.

While an example manner of implementing the audience metrics estimator 140 is illustrated in FIGS. 1 and 2, one or more of the elements, processes and/or devices illustrated in FIGS. 1 and 2 may be combined, divided, re-arranged, omitted, eliminated and/or implemented in any other way. Further, the example data storage 210, the example probability distribution generator 220, the probability divergence determiner 230, and/or, more generically, the example audience metrics estimator 140 of FIGS. 1-2 may be implemented by hardware, software, firmware and/or any combination of hardware, software and/or firmware. Thus, for example, any of the example data storage 210, the example probability distribution generator 220, the probability divergence determiner 230 and/or, more generically, the example audience metrics estimator 140 of FIGS. 1-2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data storage 210, the example probability distribution generator 220, and/or the probability divergence determiner 230 is/are hereby expressly defined to include a non-transitory computer readable storage device or storage disk such as a memory, a digital versatile disk (DVD), a compact disk (CD), a Blu-ray disk, etc. including the software and/or firmware. Further still, the example audience metrics estimator 140 may include one or more elements, processes and/or devices in addition to, or instead of, those illustrated in FIGS. 1 and 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

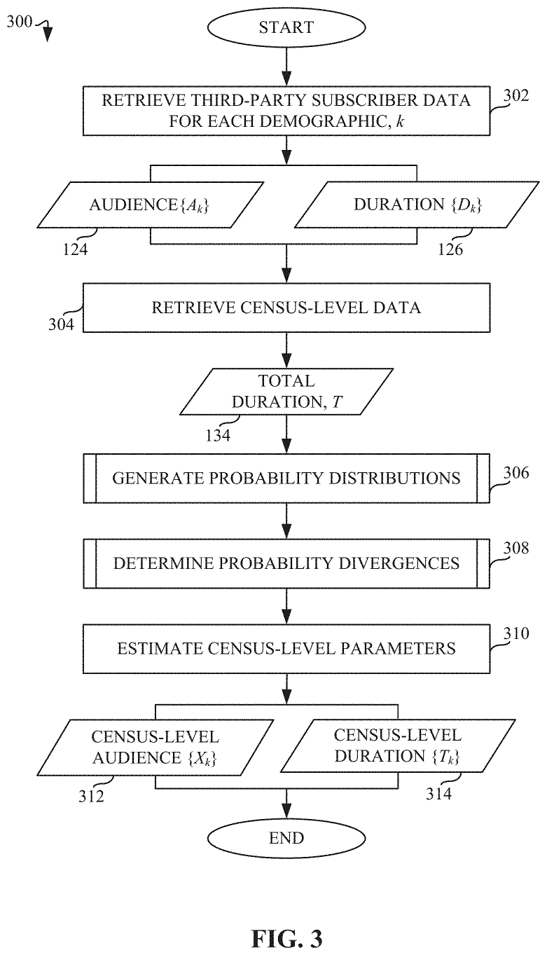

Flowcharts representative of example machine readable instructions for implementing the example audience metrics estimator 140 of FIGS. 1-2 are shown in FIGS. 3-6, respectively. The machine-readable instructions may be one or more executable programs or portion(s) of an executable program for execution by a processor such as the processor 906 shown in the example processor platform 900 discussed below in connection with FIGS. 3-6. The program may be embodied in software stored on a non-transitory computer readable storage medium such as a CD-ROM, a floppy disk, a hard drive, a digital versatile disk (DVD), a Blu-ray disk, or a memory associated with the processor 906, but the entire program and/or parts thereof could alternatively be executed by a device other than the processor 906 and/or embodied in firmware or dedicated hardware. Further, although the example program is described with reference to the flowcharts illustrated in FIGS. 3-6, many other methods of implementing the example audience metrics estimator 140 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3, 4, 5 and/or 6 may be implemented using executable instructions (e.g., computer and/or machine readable instructions) stored on a non-transitory computer and/or machine readable medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart 300 representative of machine readable instructions which may be executed to implement elements of the example audience metrics estimator 140 of FIG. 2. The example audience metrics estimator 140 retrieves third-party subscriber data (e.g., available from the database proprietor 120 of FIG. 1) for each demographic (k) from the data storage 202 of FIG. 2 (block 302). The third-party database proprietor 120 determines audience size and duration data for different demographic categories of subscribers based on subscriber data 122 collected when a subscriber is exposed to impressions (e.g., third-party media) on user devices 112. For example, a logged duration 126 is associated with a specific subscriber (e.g., users 110). Based on this data, the audience metrics estimator 140 can retrieve inputs of subscriber-based audience size {Aₖ} data (e.g., audience size data 124) and duration {Dₖ} data (e.g. duration data 126) for different aggregate demographic categories. The example audience metrics estimator 140 also retrieves census-level data from the census-level data storage 132 of the AME 130 (block 304). For example, the AME 130 can also access logged impressions that are made by users 110 when using devices 112, but the data is not associated with specific demographics of the users when such users are not members of an AME panel, such that the AME 130 can determine the total logged duration 134 (e.g., total census-level duration by users 110), while not differentiating between individual users. As such, the census-level data storage 132 provides inputs to the audience metrics estimator 140 of total census-level duration (T) data (e.g., total duration data 134). Using the third-party and census-level data, the example probability distribution generator 220 of the example audience metrics estimator 140 determines the probability of an individual in a given demographic k being a member of the third-party subscriber data (e.g., audience size {Aₖ} data, duration {Dₖ} data) and generates a probability distribution for each individual within the total population subject to these constraints, such that the distribution parameter solver 222 determines the distribution parameters that can be further used to identify potential solutions for census-level audience and duration data (block 306). Once the probability distributions have been generated, the example probability divergence determiner 230 of FIG. 2 determines probability divergences between the third-party and census-level data (block 308). Furthermore, the example probability divergence determiner 230 estimates census-level individual data (e.g., unique audience size and durations) using the census-level output calculator 238 based on the probability distribution parameters calculated using the distribution parameter solver 222 and the probability divergence parameters calculated using the divergence parameter solver 234 (block 310). The example audience metrics estimator 140 provides census-level outputs, including output estimates for census-level audience size {Xₖ} (block 312) and census-level duration {Tₖ} (block 314). As such, using census-level data (e.g., total duration 134) and third-party data (e.g., audience size 124 and duration 126), the audience metrics estimator 140 estimates the census-level unique audience 312 and duration 314 for individual demographic categories.

FIG. 4 is a flowchart 306 representative of machine readable instructions which may be executed to implement elements of the example audience metrics estimator 140 of FIG. 2, to generate probability distributions. For example, the probability distribution generator 220 assigns probability density functions [pₜ^{(t)}] for panel audience individuals (i) using durations (t) (block 402). Each person has a fixed, but unknown, number of impressions (n) and duration time (t) across all of the (unknown) impressions, both in the census-level and third-party database (e.g., ‘John Smith’ has a duration totaling 20 minutes, of which only 10 minutes were registered in a database, or none at all). However, aggregate information obfuscates the person-specific data and leaves a reference aggregate among the individuals within a demographic, such that the uncertainty for each person can be expressed in the form of a probability distribution. Such a distribution is a mixture of a point mass distribution and a continuous distribution. The point mass distribution is at t=0, indicating that the individual did not view any pages, thereby resulting in no duration. The continuous distribution is continuous along the open interval (0,∞).

For purposes of deriving the solution to individual probability distribution estimates using the example probability distribution generator 220, an assumption is made that there are a total of U individuals in the total population. The uncertainty with a collection of U probability distributions going across the possibility of each individual having any durations (t), along with not having any durations, can be expressed for each person, such that, for example, if U=5, persons 1-5 are assigned probabilities as follows: [p₀⁽¹⁾,{pₜ⁽¹⁾:t>0}], [p₀⁽²⁾,{pₜ⁽²⁾:t>0}], [p₀⁽³⁾,{pₜ⁽³⁾:t>0}], [p₀⁽⁴⁾,{pₜ⁽⁴⁾:t>0}], and [p₀⁽⁵⁾,{pₜ⁽⁵⁾:t>0}]. The probability distribution generator 220 assigns p⁽ⁱ⁾ as the probability that the i^{th} person did not have any durations (e.g., point mass distribution), and assigns pₜ⁽ⁱ⁾ as the probability density function that represents the probabilities that the i^{th} person has a duration t. For example, the probability distribution generator 220 assigns the probability (Pr) that an individual has an aggregate total duration between t₁ and t₂ time units across an unknown number of impressions (e.g., an individual watched between 20 to 30 minutes of different videos, but the number of individual videos watched is unknown), in accordance with Equation 1 below, with the total probability equivalent to one, as shown in Equation 2, such that an individual has a total duration of zero or any positive real value:

Pr(t₁<t<t₂)=∫ₜ_{₁}^{t}^{₂}pₜ^{(t)}dt Equation 1

p₀^{(t)}+∫₀^{∞}p_{T}^{(I)}dt=1 Equation 2

The probability distribution generator 220 assigns every individual within a given demographic the same probability distribution if no further information of individual behavior is available except for the known total behavior (e.g., given a total of 100 individuals with a known total duration of 600 minutes, each individual is assigned an average duration of 6 minutes). Given that the probability distribution generator 220 has access to both audience and duration information from the third-party subscriber data 122 (e.g., audience size 124 and duration 126), the probability distribution generator 220 assigns a person-specific probability distribution (II) for individuals within a demographic using the probability of being in the audience (d₁) and the average duration per individual (d₂) (block 404). Such a person-specific distribution can be expressed in accordance with Equations 3-6 below:

$$\begin{matrix}\begin{matrix}maximize \\ P\end{matrix} H = ( - {p}_{0} log ( {p}_{0} ) ) + ( - {\int }_{0}^{∞} {p}_{t} log ( {p}_{t} ) dt ) & Equation 3 \\ subject to {p}_{0} + {\int }_{0}^{∞} {p}_{t} dt = 1 & Equation 4 \\ {\int }_{0}^{∞} {p}_{t} dt = {d}_{1} & Equation 5 \\ {\int }_{0}^{∞} {tp}_{t} dt = {d}_{2} & Equation 6\end{matrix}$$

The probability distribution generator 220 can re-arrange the solution to the person-specific distribution problem of Equations 3-6 (e.g., express in terms of z notation) in accordance with Equations 7-10, subject to the final solution for the set of {z,} expressed in accordance with Equation 7 (block 406):

$$\begin{matrix} {p}_{t} = \{ \begin{matrix}{z}_{0} & t = 0 \\ {z}_{0} {z}_{1} {z}_{2}^{t} & t > 0\end{matrix} & Equation 7 \\ {p}_{0} + {\int }_{0}^{∞} {p}_{t} dt = {z}_{0} + {\int }_{0}^{∞} {z}_{0} {z}_{1} {z}_{2}^{t} dt = {z}_{0} - \frac{{z}_{0} {z}_{1}}{log ( {z}_{2} )} = 1 & Equation 8 \\ {\int }_{0}^{∞} {p}_{t} dt = {\int }_{0}^{∞} {z}_{0} {z}_{1} {z}_{2}^{t} dt = - \frac{{z}_{0} {z}_{1}}{log ( {z}_{2} )} = {d}_{1} & Equation 9 \\ {\int }_{0}^{∞} {tp}_{t} dt = {\int }_{0}^{∞} {tz}_{0} {z}_{1} {z}_{2}^{t} dt = \frac{{z}_{0} {z}_{1}}{{( log ( {z}_{2} ) )}^{2}} = {d}_{2} & Equation 10\end{matrix}$$

The distribution parameter solver 222 solves for z₀, z₁, and z₂ (block 408). For example, the direct solutions to z₀, z₁, and z₂ can be represented in accordance with Equations 11, 12, and 13, respectively:

$$\begin{matrix}{z}_{0} = 1 - {d}_{1} & Equation 11 \\ {z}_{1} = \frac{{d}_{1}^{2}}{( 1 - {d}_{1} ) {d}_{2}} & Equation 12 \\ {z}_{2} = {e}^{- \frac{{d}_{1}}{{d}_{2}}} & Equation 13\end{matrix}$$

Once a solution to the individual probability distribution estimate is available, a probability of a given duration characteristic can be calculated for each individual (e.g., audience member). For example, if among 100 individuals there is an audience of 50 people and 200 time units of duration, the total probability (z₀), the probability of being in the audience (z₁), and the probability of duration (z₂) can solved for as shown below in Example 1, based on Equations 11-13:

$$\begin{matrix}{d}_{0} = \frac{100}{100} \to {z}_{0} = 1 - {d}_{1} = 0.5 \\ {d}_{1} = \frac{50}{100} \to {z}_{1} = \frac{{d}_{1}^{2}}{( 1 - {d}_{1} ) {d}_{2}} = 0.25 \\ {d}_{2} = \frac{200}{100} \to {z}_{2} = {e}^{- \frac{{d}_{1}}{{d}_{2}}} = {e}^{- \frac{1}{4}}\end{matrix} \qquad Example 1$$

In this example, the probability of a given duration characteristic can be calculated for each individual, such that if p₀=z₀=0.5, there is a 50% chance of the individual not viewing any duration. To estimate the probability of the audience in this example having a duration of at most 5 time units, the audience metric estimator 140 can apply Equation 1 to generate an estimate, as shown below in Example 2:

$$Pr ( 0 < t < 5 ) = {\int }_{0}^{5} {p}_{t} dt = {\int }_{0}^{5} \frac{1}{8} {e}^{- \frac{1}{4}} dt \approx 0.356 \qquad Example 2$$

FIG. 5 is a flowchart 308 representative of machine readable instructions which may be executed to implement elements of the example audience metrics estimator 140 of FIG. 2, the flowchart representative of instructions used to determine probability divergences. Once the audience metrics estimator 140 generates probability distributions using the probability distribution generator 220, as described above in connection with FIG. 4, the probability divergence determiner 230 determines probability divergences. A probability divergence allows for a comparison between two probability distributions. In the examples disclosed herein, the probability divergence permits a comparison between the distribution of third-party subscriber data and the distribution of census-level data. In the examples disclosed herein, a Kullback-Leibler probability divergence (KL divergence) is used to measure the difference between these two probability distributions (e.g., determine how well one probability distribution approximates another probability distribution). For example, the probability divergence determiner 230 defines third-party subscriber data as a prior distribution (Q) and census-level data as a posterior distribution (P). The audience size and durations are equally divided across the entire population of individuals in a k^{th} demographic (Uₖ), such that U is representative of a population universe estimate. A universe estimate (e.g., a total audience) can be defined as, for example, the total number of persons that accessed the media in a particular geographic scope of interest and/or during a time of interest relating to media audience metrics. For example, the universe estimate can be based on census-level data 132 obtained by the AME 130 during assessment of logged impressions by user devices 112. For example, the k^{th} demographic can represent a demographic category (e.g., females 35-40, males 35-40, etc.). As such, the probability divergence determiner 230 defines third-party data as a prior probability distribution in the k^{th} demographic (Qₖ) (block 502) and census-level data as a posterior probability distribution in the k^{th} demographic (Pₖ) (block 504) in a manner consistent with Equations 19-22:

$$\begin{matrix}{d}_{0}^{Q} = 1 {d}_{0}^{P} = 1 & Equation 14 \\ {d}_{1}^{Q} = \frac{{A}_{k}}{{U}_{k}} {d}_{1}^{P} = \frac{{X}_{k}}{{U}_{k}} & Equation 15 \\ {d}_{2}^{Q} = \frac{{D}_{k}}{{U}_{k}} {d}_{2}^{P} = \frac{{T}_{k}}{{U}_{k}} & Equation 16\end{matrix}$$

In Equations 14-16, the probability that a specific individual in the k^{th} demographic is a member of the third-party aggregated subscriber audience total (Aₖ) is defined as Aₖ/Uₖ and the probability that a specific individual in the k^{th} demographic has a duration in the third-party aggregated duration total (Dₖ) is defined as Dₖ/Uₖ. In the examples disclosed herein, the audience metrics estimator 140 accesses third-party data (e.g., subscriber data 122 of FIG. 1), which provides anonymized aggregate data for subscriber audience (Aₖ) and durations (Dₖ) (e.g., audience 124 and duration 126 data, respectively, of FIG. 1). However, for census-level data, the audience metric estimator 140 only has access to census-level total durations 134. In Equations 14-16, the probability that a specific individual in the k^{th} demographic is a member of the census-level unique audience total (Xₖ) is defined as Xₖ/Uₖ and the probability that a specific individual in the k^{th} demographic has a duration in the census-level duration total (Tₖ) is defined as Tₖ/Uₖ. Once the probability divergence determiner 230 has defined the prior and posterior distributions for the third-party subscriber data and the census-level data (blocks 502 and 504), respectively, the divergence parameter solver 234 determines divergences between prior and posterior distributions in the k^{th} demographic in order to find solutions for the census-level unique audience and duration (block 506), as detailed below in connection with FIG. 6.

FIG. 6 is a flowchart 506 representative of machine readable instructions which may be executed to implement elements of the example audience metrics estimator 140 of FIG. 2, the flowchart representative of instructions used to determine probability divergences of FIG. 5. Except for having different values, the prior (Qₖ) and posterior (Pₖ) distributions are in the same domain and have the same linear constraints. Therefore, the divergence parameter solver 234 represents the divergence (e.g., Kullback-Leibler divergence KL(Pₖ:Qₖ), where Pₖ is a posterior probability distribution representing census-level data and Qₖ is a prior probability distribution representing third-party subscriber data) of an individual from third-party subscriber data to census-level data in accordance with Equation 17:

$$KL ( {P}_{k} \text{:} {Q}_{k} ) = {\sum }_{j = 0}^{m} {d}_{j}^{P} log ( \frac{{z}_{j}^{P}}{{z}_{j}^{Q}} ) \qquad Equation 17$$

In Equation 17, the divergence parameter solver 234 expresses the KL divergence in terms of z notation, referring to the solutions to z₀, z₁, and z₂ determined in Equations 11-13 as previously described, and reproduced below as Equations 24-27. In some examples, the divergence parameter solver 234 expands Equation 17 to yield a description of how any given individual's distribution within the k^{th} demographic can change, in accordance with Equation 18:

$$KL ( {P}_{k} \text{:} {Q}_{k} ) = {\sum }_{j = 0}^{m} {d}_{j}^{P} log ( \frac{{z}_{j}^{P}}{{z}_{j}^{Q}} ) = {\sum }_{j = 0}^{m} {d}_{j}^{P} [ log ( {z}_{j}^{P} ) - log ( {z}_{j}^{Q} ) ] = ( {d}_{0}^{P} ) [ log ( {z}_{0}^{P} ) - log ( {z}_{0}^{Q} ) ] … + ( {d}_{1}^{P} ) [ log ( {z}_{1}^{P} ) - log ( {z}_{1}^{Q} ) ] … + ( {d}_{2}^{P} ) [ log ( {z}_{2}^{P} ) - log ( {z}_{2}^{Q} ) ] … \qquad Equation 18$$

Given that all individuals in a k^{th} demographic are assumed to have the same behavior, the divergence parameter solver 234 multiplies KL(Pₖ:Qₖ) by the number of individuals in the k^{th} demographic (Uₖ) to determine how the individuals within a demographic can change collectively (e.g., since the divergences are the same, multiplication is used instead of adding the KL-divergence of each individually together). To determine the total divergence across the population, the divergence parameter solver 234 sums across all divergences and across all demographics, in accordance with Equation 19:

KL(P:Q)=Σₖ₌₁^{K}Uₖ(KL)Pₖ:Qₖ)) Equation 19

To fully describe the behavior of audiences and durations, the divergence parameter solver 234 minimizes Equation 19 in accordance with Equation 20:

$$\begin{matrix}minimize \\ \{ {T}_{k} \} , \{ {X}_{k} \}\end{matrix} KL ( P : Q ) = {\sum }_{k = 1}^{K} {U}_{k} ( KL ( {P}_{k} \text{:} {Q}_{k} ) ) \\ subject to {\sum }_{k = 1}^{K} {T}_{k} = T \qquad Equation 20$$

In Equation 20, {Xₖ} and {Tₖ} represent census-level data pertaining to unique audience size impression duration, respectively, all of which are unknown. However, Equation 20 is subject to sum of the values of the unique audience size durations {Tₖ} being equal to the total census-level duration (7) (e.g., total duration 134), which is also referred to herein as the equality constraint. In some examples, the divergence parameter solver 234 solves the system of Equation 20 by taking a Lagrangian ( [symbol] ) of the system in accordance with Equations 21-23 (e.g., solving for when the 2K+1 system of equations are all zero), where the solution is for all (∀) demographics k={1, 2, . . . , K}, in addition to setting the partial derivative with respect to the Lagrange multiplier (λ) equal to 0 (e.g., Equation 24):

$$\begin{matrix}ℒ = KL ( P \text{:} Q ) - λ ( {\sum }_{k = 1}^{K} {T}_{k} - T ) & Equation 21 \\ \frac{\partial ℒ}{\partial {T}_{k}} = 0 ∀ k = \{ 1 , 2 , … , K \} & Equation 22 \\ \frac{\partial ℒ}{\partial {X}_{k}} = 0 ∀ k = \{ 1 , 2 , … , K \} & Equation 23 \\ \frac{\partial ℒ}{\partial λ} = 0 & Equation 24\end{matrix}$$

The divergence parameter solver 234 solves the Lagrangian of Equation 21 using the Lagrange multiplier (λ) to represent the census-level total duration constraint (Σₖ₌₁^{K} Tₖ=T). Other than the constraint of total duration across demographics (λ), each demographic is mutually exclusive and does not impact the other demographics. Therefore, besides that addition of the constraints noted above, the Lagrangian-based ( [symbol] ) derivative of census-level unique audience size {Xₖ}, and duration {Tₖ} involve terms of the same demographic (e.g., females 35-40 years of age). As such, the Lagrangian-based ( [symbol] ) derivative of census-level unique audience size {Xₖ} and duration {Tₖ} can be expressed in accordance with Equations 25 and 26, respectively:

$$\begin{matrix}\frac{\partial ℒ}{\partial {X}_{k}} = log ( \frac{{X}_{k}^{2}}{{T}_{k} ( {U}_{k} - {X}_{k} )} ) - log ( \frac{{A}_{k}^{2}}{{D}_{k} ( {U}_{k} - {A}_{k} )} ) & Equation 25 \\ \frac{\partial ℒ}{\partial {T}_{k}} = \frac{{A}_{k}}{{D}_{k}} - \frac{{X}_{k}}{{T}_{k}} - λ & Equation 26\end{matrix}$$

The audience metrics estimator 140 determines solutions to the census-level individual data {Xₖ, Tₖ} based on Equations 25 and 26, where both Xₖ and Tₖ appear within each equation, such that these equations can be solved simultaneously when equaled to zero. The solution to {Xₖ} can be expressed in accordance with Equation 27, whereas the solution to {Tₖ} can be expressed in accordance with Equation 29 based on Equation 28:

$$\begin{matrix}{\hat{X}}_{k} = \frac{{A}_{k}}{1 - ( 1 - \frac{{A}_{k}}{{U}_{k}} ) ( \frac{{D}_{k}}{{A}_{k}} ) λ} & Equation 27 \\ \frac{{\hat{X}}_{k}}{{\hat{T}}_{k}} = \frac{{A}_{k}}{{D}_{k}} - λ & Equation 28 \\ {\hat{T}}_{k} = \frac{{\hat{X}}_{k}}{( \frac{{A}_{k}}{{D}_{k}} - λ )} & Equation 29\end{matrix}$$

As part of the solution, the search space identifier 232 establishes a bounded interval based on census-level total duration (λ) equality constraint (blocks 602, 604). For example, minimization across all demographics can be expressed in terms of the inequality of Equation 30, such that the estimate of Xₖ increases as total duration (λ) increases and a maximum limit for Xₖ is reached at the total number of individuals within the demographic k (Uₖ):

$$0 \leq λ \leq min ( \frac{{A}_{k}}{{D}_{k}} ) \qquad Equation 30$$

In Equation 30, the upper limit for the value of the census-level total duration (λ) equality constraint for any demographic k can be defined as the ratio of third-party subscriber audience size (Aₖ) to third-party duration (Dₖ). Likewise, the value for the census-level total duration (λ) equality constraint is below the minimum limit across all demographics. At λ=0, there is no change in the estimate of census-level duration per demographic (Tₖ) from third-party subscriber duration per demographic (Dₖ), such that Tₖ=Dₖ and Xₖ=Aₖ, making the census estimates replicate the third-party subscriber information. This holds true if there is no constraint on any census variable and the KL divergence is minimized as much as possible, such that the minimum, with no restrictions, is equal to the prior. Furthermore, as λ approaches negative infinity (λ→−∞), both Xₖ and Tₖ go to zero (e.g., this can be applicable when the census total duration is less than the third-party subscriber estimate). If the average duration viewed per demographic is defined as cₖ=Dₖ/Aₖ, the index k of the minimum is identical to the same index as the largest duration cₖ among the demographics. For example, if the highest duration among the demographics is defined as c*, the equality constraint from Equation 30 can be rewritten in accordance with Equation 31:

$$- ∞ < λ \leq ( \frac{1}{{c}^{*}} ) \qquad Equation 31$$

Furthermore, if the third-party total duration (D) is set to be less than or equal to the total census-level duration (T) (e.g., D≤7), the search space identifier 232 can upscale the durations to match a larger total duration, such that the bounded interval (e.g., equality constraint) can be expressed in accordance with Equation 32:

$$0 \leq λ \leq ( \frac{1}{{c}^{*}} ) \qquad Equation 32$$

When the audience metrics estimator 140 estimates the census-level audience size {Xₖ} and census-level duration {Tₖ} for each demographic based on solutions to z₀, z₁, and z₂ (block 606), the search space identifier 232 verifies that the above equality constraint (e.g., Equation 30 and Equation 32) is met (block 608). For example, the iterator 236 can iterate over a given search space until the equality constraint is met, while the census-level output calculator 238 outputs the final census-level individual data the meets the given constraints. As such, access to the third-party subscriber data allows the audience metrics estimator 140 to estimate the census-level unique audience size and duration by solving for {Xₖ, Tₖ}.

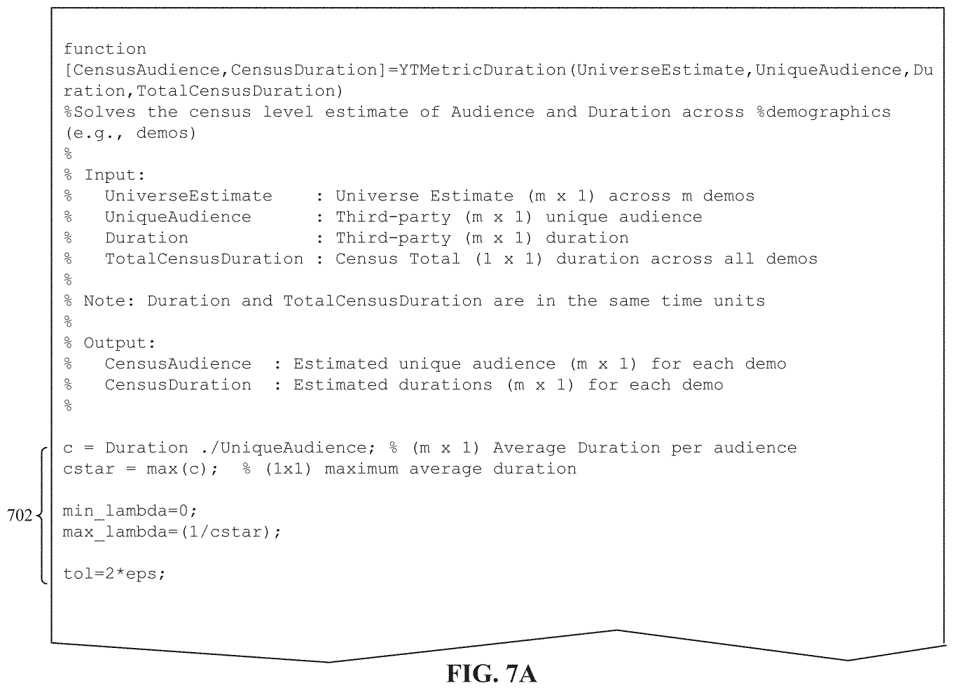

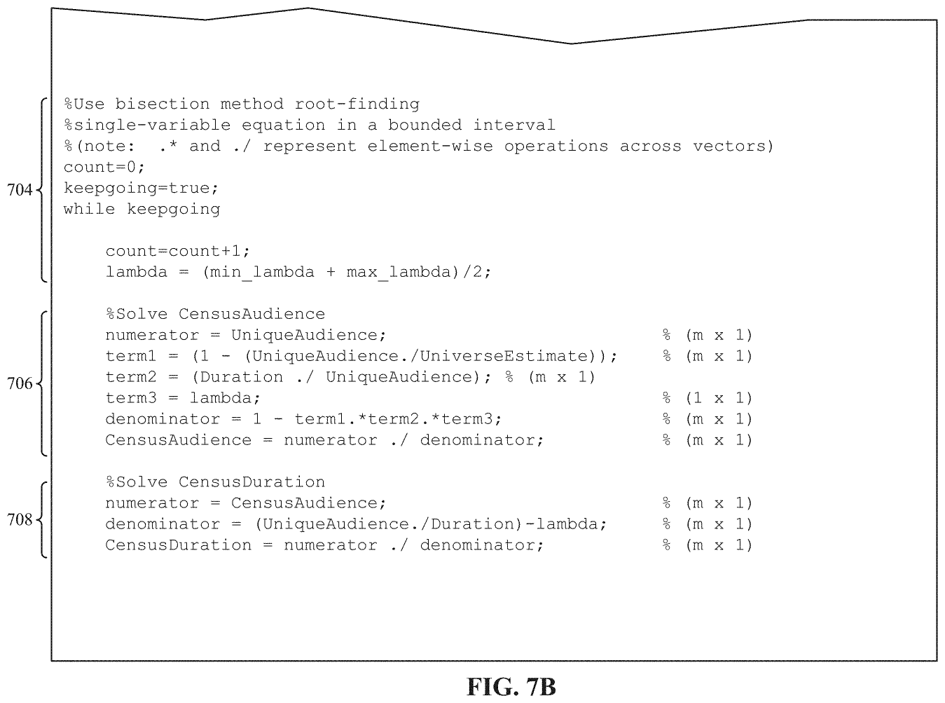

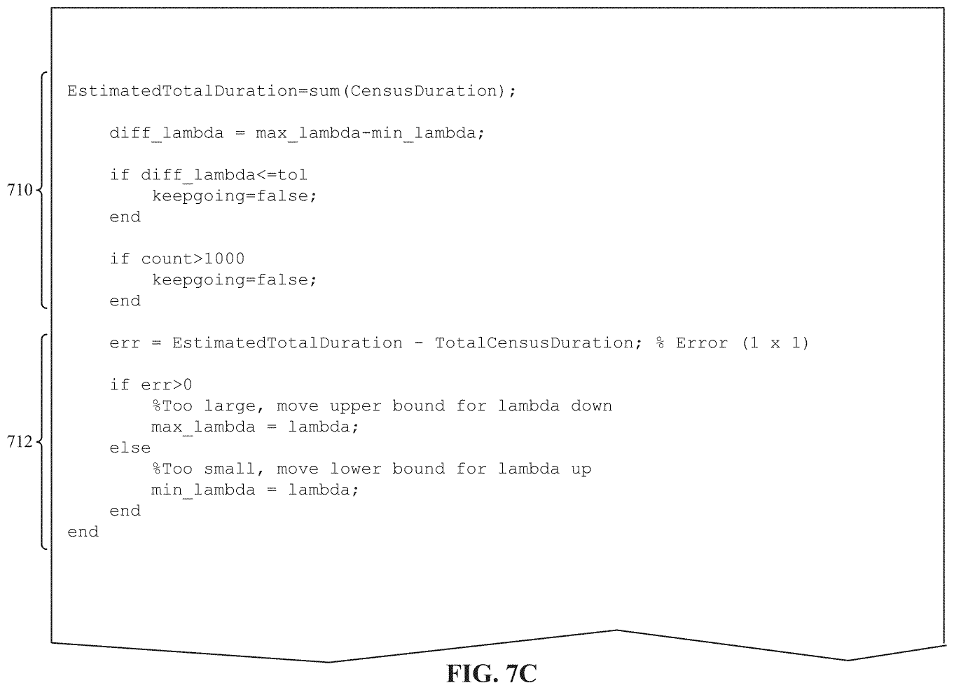

FIGS. 7A-7C include example programming code representative of machine readable instructions that may be executed to implement the example audience metrics estimator of FIGS. 1-2 to estimate census-level unique audience size 312 and census-level duration 314 across multiple demographics based on third-party subscriber data 122 (e.g., audience size 124 and duration 126) and census-level total duration 134. The example instructions of FIGS. 3-6 may be used in a MATLAB development environment. However, similar instructions may be employed to implement techniques disclosed herein in other development environments. In FIG. 7A, the example instructions at reference number 702 define the average duration per audience as cₖ=Dₖ/Aₖ and define the highest duration among the demographics as c* (e.g., cstar), as described in connection with FIG. 6 above. This allows the equality constraint, which should be met when solving for census-level estimates, to be defined based on Equation 32 (e.g., using min lambda and max lambda). In FIG. 7B, example instructions at reference number 704 implement a bisection method root finding to solve for census-level estimates (e.g., CensusAudience and CensusDuration). While the bisection method root finding is used in this example, any other method can be implemented to perform the census-level estimation based on the derivations described in connection with FIGS. 3-6. The instructions at reference number 704 implement a loop to solve for the census-level estimates while meeting the equality constraint defined by instructions at reference number 702. Example instructions at reference number 706 solve for the census-level estimate of unique audience size (e.g., CensusAudience), while example instructions at reference number 708 solve for the census-level estimate of duration (e.g., CensusDuration). In FIG. 7C, example instructions at reference number 710 set the expected total census-level duration (e.g., EstimatedTotalDuration) equivalent to the sum of determined demographic-based census-level durations (e.g., CensusDuration). Example instructions at reference number 712 determine the upper and lower bounds for the equality constraint (e.g., X of Equation 32) based on whether the difference between the estimated census-level total duration and the duration across all demographics (e.g., total duration 134). For example, if the difference is greater than zero, the upper bound for the equality constraint is moved down. Otherwise, the lower bound for the equality constraint is moved up. Therefore, the search space as defined by the search space identifier 216 can vary depending on the calculated values for the estimated total census-level duration.

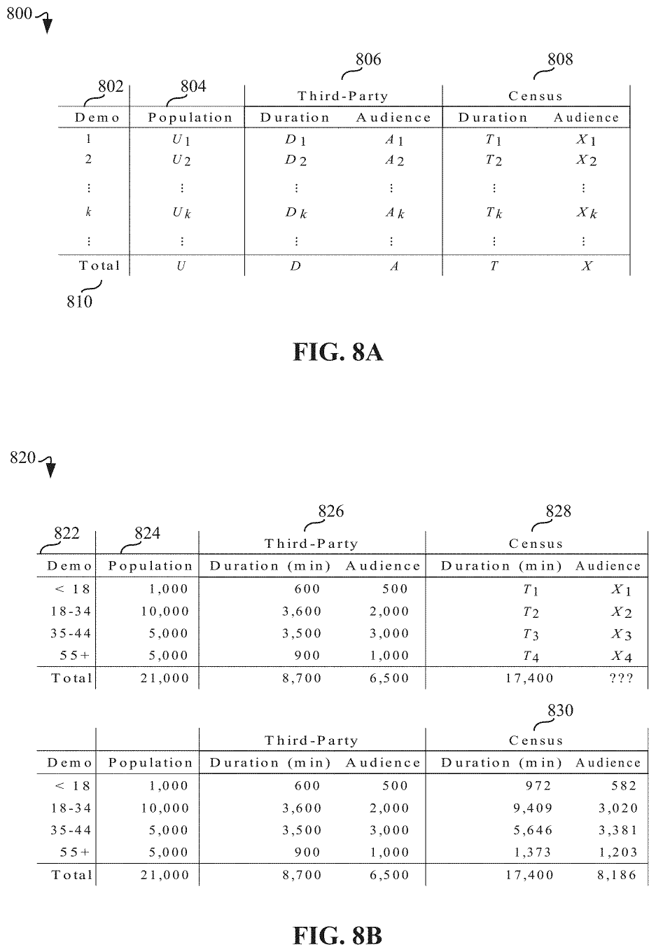

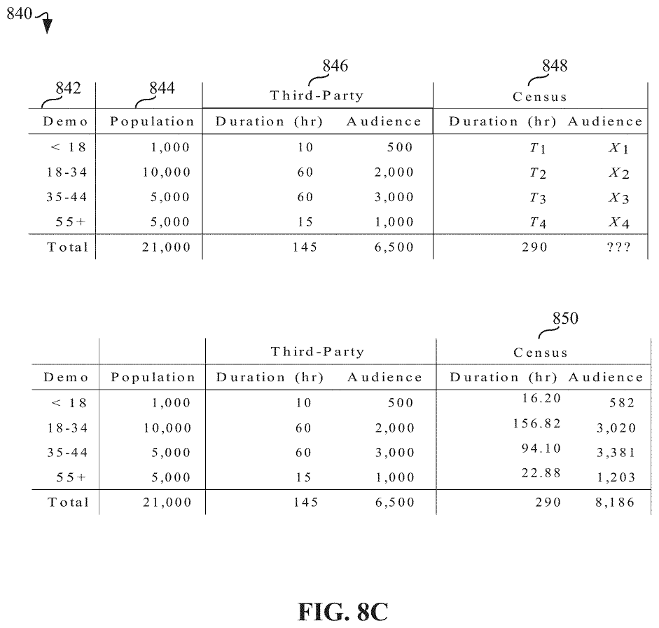

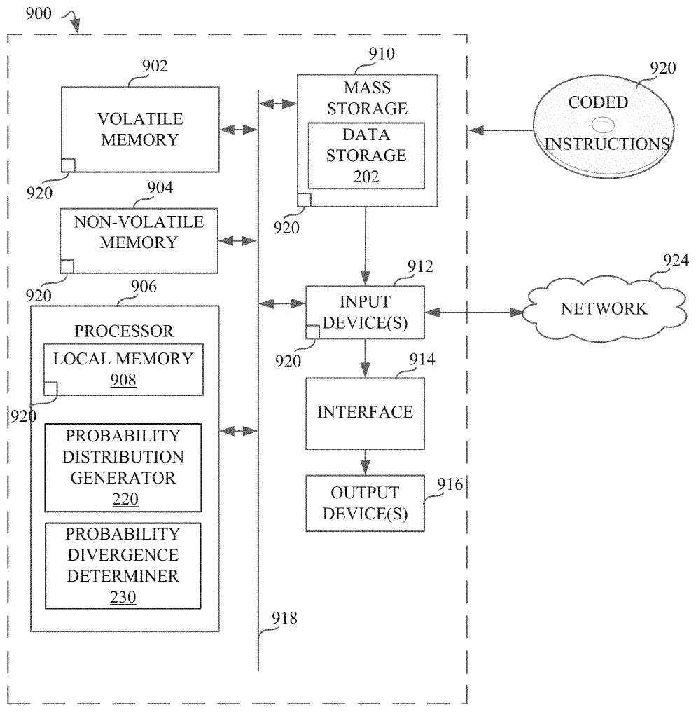

FIGS. 8A-8C include example data sets providing third-party subscriber and census-level data, including total duration data used by the example audience metrics estimator 140 of FIGS. 1-2 to generate census-level estimations of unique audience and duration across demographics. FIG. 8A sets forth a table 800 with the notations used throughout when determining census-level data based on third-party subscriber data. For example, reference number 802 identifies the demographics k (e.g., demographic 1 can refer to females aged 35-40, demographic 2 can refer to males aged 35-40, etc.). Reference number 804 identifies the population (e.g., universe audience (U) for each demographic, (Uₖ)). Reference number 806 identifies third-party subscriber data, including subscriber data for audience size (Aₖ) and duration (Dₖ). Reference number 808 identifies census-level data, including census-level unique audience (Xₖ) and census-level duration (Tₖ). Reference number 810 identifies the total counts for each data group, including total universe audience (U), third-party total audience size (A), third-party total duration (D), census-level total audience size (X), and census-level total duration (7).

FIG. 8B shows a table 820 with an example set of data available from third-party subscriber data 122 of FIG. 1 and an example set of data available for census-level total duration 134 of FIG. 1. For example, a total of four different demographics (k) (reference number 822) are considered (e.g., population that is younger than 18 years of age, population between 18-34 years of age, population between 35-44 years of age, and population 55 years of age and older). The population 824 (e.g., universe audience, Uₖ) for each demographic (e.g., k=1-4) ranges from a total of 1,000 to a total of 10,000. Third-party subscriber data 826 includes audience size and duration values for each demographic, as well as values for total audience size and total durations. Census-level data 828 includes only total duration (e.g., 17,400), whereas demographic-specific unique audience size and duration, as well as the total unique audience size, are all variables to be solved for using the methods described throughout this application and applied in the examples below. For example, using data available from example table 820, the highest average duration among each demographic is for the 18-34 age range demographic (e.g., maximum of 3,600 minutes). This data is used to determine cₖ=Dₖ/Aₖ (e.g., D₁₈₋₃₄/A₁₈₋₃₄=3,600/2,000=1.8), as described in association with FIG. 6. Based on this calculation, Equation 32 can be used to further determine the search space (e.g., using the search space identifier 216), as shown in Example 3, where the upper limit of the search space bound is the multiplicative inverse of cₖ (e.g., where cₖ represents that higher average duration throughout the demographics, as defined by c*):

$$0 \leq λ \leq ( \frac{1}{1.8} ) \qquad Equation 3$$

For each value of λ in the search space interval of the Example 3 equation, the estimated census-level audience size can be calculated based on Equation 27 (reproduced below), and the estimated census duration can be calculated based on Equation 29 (reproduced below), until the total duration constraint is matched. For example, using λ=0.2346 for Equations 27 and 29 yields a set of values for each demographic that represents the solution to the census-level 830 unique audience size {Xₖ} and census-level duration {Tₖ} (Example 4):

$$\begin{matrix}{\hat{X}}_{k} = \frac{{A}_{k}}{1 - ( 1 - \frac{{A}_{k}}{{U}_{k}} ) ( \frac{{D}_{k}}{{A}_{k}} ) λ} & Equation 27 \\ {\hat{T}}_{k} = \frac{{\hat{X}}_{k}}{( \frac{{A}_{k}}{{D}_{k}} - λ )} & Equation 29 \\ \hat{X} = \{ 582 \; 3 , 020 \; 3 , 381 \; 1 , 203 \} & Example 4 \\ \hat{T} = \{ 972 \; 9 , 409 \; 5 , 646 \; 1 , 373 \} & \end{matrix}$$

Example 4 yields {Xₖ} and {Tₖ} values that are determined using λ=0.2346 (where 0≤X≤0.555), since at this λ value the duration constraint set by Equation 20 (reproduced below) can be satisfied (e.g., sum of all census-level durations Tₖ is equivalent to the total known census-level duration, T):

$${minimize}_{\{ {T}_{k} \} , \{ {X}_{k} \}} KL ( P \text{:} Q ) = {\sum }_{k = 1}^{K} {U}_{k} ( KL ( {P}_{k} : {Q}_{k} ) ) subject to {\sum }_{k = 1}^{K} {T}_{k} = T \\ \qquad Equation 20$$

FIG. 8C shows a table 840 with an example set of data 846 available from third-party subscriber data 122 of FIG. 1 and an example set of data 848 available for census-level total duration 134 of FIG. 1. In the example table 840 of FIG. 8C, the duration of the third-party subscriber data 846 has the same audience size data demographics 842, as well as the same population size 844, as that of table 820 of FIG. 8B. However, the duration of the third-party subscriber data 846 is much shorter per demographic 842 than that shown in table 820 of FIG. 4B, given that the unit of duration measurement is changed from minutes to hours. For example, if duration is changed to a new unit (e.g., by multiplying by a scaling factor), the final estimate of census-level durations also scale by the same factor, while the estimate of audience size remain unchanged. For example, the third-party subscriber data 826 durations of FIG. 8B are divided by 60 (e.g., changing minutes to hours or seconds to minutes, depending on the original units), to yield the third-party subscriber data 846 durations per demographic k. The solution process as described for FIG. 8B remains the same for the data shown in FIG. 8C. For example, the search space can be defined using Example 5, based on the values for the demographic having the maximum duration per the total number of audience members (e.g., 60 hours for 2,000 individuals):

$$0 \leq {λ}^{′} \leq ( \frac{1}{0.03} ) \qquad Example 5$$

For λ′=14.0746, the solutions for the census-level audience size {Xₖ} and census-level duration {Tₖₗ} can be determined for all demographics, as shown in the populated census-level portion 850 of the example table 840 of FIG. 8C. As such, the estimated census-level audience remains the same as in the example of FIG. 8B, while all estimated census-level durations are scaled by the same factor as the input (e.g., changing from minutes to hours changes the scale by a factor of 60). Likewise, λ is also scaled in the opposite direction to counteract the scaling of durations (e.g., λ′/λ=14.0746/0.2346=60). Given that time units for duration can be in any scale, the duration solution scales by the same factor. Therefore, the use of units for duration (e.g., minutes, hours, or seconds) can be any unit selected as long as the unit is consistent throughout the referenced data. As shown using the example tables 820 and 840, the audience estimate is scale independent while the duration estimates are scale invariant. As such, the audience estimates are not changed when using different time unit scales, while the duration estimates scale by the same factor. For example, Equation 33 represents scale independence of the audience estimate, where s is the scale factor for the time and the new solution for λ for that scale is represented by λ′, such that equality is reached when λ′=λ/s:

$$\frac{{A}_{k}}{1 - ( 1 - \frac{{A}_{k}}{{U}_{k}} ) ( \frac{( {sD}_{k} )}{{A}_{k}} ) {λ}^{′}} = \frac{{A}_{k}}{1 - ( 1 - \frac{{A}_{k}}{{U}_{k}} ) ( \frac{{D}_{k}}{{A}_{k}} ) λ} \qquad Equation 33$$

Likewise, scale invariance of census-level duration can be represented in accordance with Equation 34, where X′ₖ is the primed audience and Xₖ (unprimed) is the original audience estimate, such that equality is again reached when λ′=λ/s:

$$\frac{{\hat{X}}_{k}^{′}}{( \frac{{A}_{k}}{( {sD}_{k} )} - {λ}^{′} )} = S \frac{{\hat{X}}_{k}}{( \frac{{A}_{k}}{{D}_{k}} - λ )} \qquad Equation 34$$

As such, the census-level audience estimate remains unchanged and census-level duration is scaled appropriately, given that these properties are preserved at λ′=λ/s, where λ represents the solution to the original data and constraints, while the solution as a result of time-scaling is the same λ, albeit divided by the scale factor (s).

In the examples disclosed above, the population is assumed to be a finite population. However, if a population is assumed to be infinite, valid applications in which the disclosed equations used to determine census-level solutions can be simplified can include: (1) individual populations are unknown, with only demographic proportions of the populations, and/or (2) values of the given data are so small (e.g., compared to even a lower bound of universe estimate populations) that taking into account a finite population is unnecessary and can even have a negligible effect when assuming an infinite population. For example, to solve using an infinite population, an assumption consistent with Equation 35 can be made for some population proportion πₖ, such that the universe audience approaches infinity (U→∞):

Uₖ=πₖU Equation 35

Using Equation 35 to perform a substitution for Uₖ in the original Equation 27 (e.g., solution for census-level unique audience estimate) yields Equation 36:

$${\hat{X}}_{k} = \frac{{A}_{k}}{1 - ( 1 - \frac{{A}_{k}}{{π}_{k} U} ) ( \frac{{D}_{k}}{{A}_{k}} ) λ} \qquad Equation 36$$

Furthermore, as the universe audience approaches infinity (U cc), Equation 36 can be rewritten as Equation 37:

$${\hat{X}}_{k} = \frac{{A}_{k}}{1 - ( \frac{{D}_{k}}{{A}_{k}} ) λ} \qquad Equation 37$$

A substitution of Equation 37 into original Equation 29 (e.g., representing a solution to the census-level duration estimate) yields the analytical formula of Equation 38:

$${\hat{T}}_{k} = \frac{{D}_{k}}{{( 1 - ( \frac{{D}_{k}}{{A}_{k}} ) λ )}^{2}} \qquad Equation 38$$

The search space bounds, however, remain unchanged, such that Equation 30 remains valid and can be used to solve for census-level unique audience and duration estimates using the infinite population (e.g., universe audience) assumption.

FIG. 9 is a block diagram of an example processing platform structured to execute the instructions of FIGS. 3-6 to implement the example audience metrics estimator of FIGS. 1-2. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 900 of the illustrated example includes a processor 906. The processor 906 of the illustrated example is hardware. For example, the processor 906 can be implemented by one or more integrated circuits, logic circuits, microprocessors, GPUs, DSPs, or controllers from any desired family or manufacturer. The hardware processor 906 may be a semiconductor based (e.g., silicon based) device. In this example, the processor 906 implements the example probability distribution generator 220 and the example probability divergence determiner 230 of FIG. 2.

The processor 906 of the illustrated example includes a local memory 908 (e.g., a cache). The processor 906 of the illustrated example is in communication with a main memory including a volatile memory 902 and a non-volatile memory 904 via a bus 918. The volatile memory 902 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 904 may be implemented by flash memory and/or any other desired type of memory device. Access to the main memory 902, 904 is controlled by a memory controller.

The processor platform 900 of the illustrated example also includes an interface circuit 914. The interface circuit 914 may be implemented by any type of interface standard, such as an Ethernet interface, a universal serial bus (USB), a Bluetooth® interface, a near field communication (NFC) interface, and/or a PCI express interface.

In the illustrated example, one or more input devices 912 are connected to the interface circuit 914. The input device(s) 912 permit(s) a user to enter data and/or commands into the processor 906. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 916 are also connected to the interface circuit 914 of the illustrated example. The output devices 916 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 914 of the illustrated example, thus, typically includes a graphics driver card, a graphics driver chip and/or a graphics driver processor.

The interface circuit 914 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 924. The communication can be via, for example, an Ethernet connection, a digital subscriber line (DSL) connection, a telephone line connection, a coaxial cable system, a satellite system, a line-of-site wireless system, a cellular telephone system, etc.

The processor platform 900 of the illustrated example also includes one or more mass storage devices 910 for storing software and/or data. Examples of such mass storage devices 910 include floppy disk drives, hard drive disks, compact disk drives, Blu-ray disk drives, redundant array of independent disks (RAID) systems, and digital versatile disk (DVD) drives. The mass storage device 910 includes the example data storage 210 of FIG. 2.

Machine executable instructions 920 represented in FIGS. 3-6 may be stored in the mass storage device 920, in the volatile memory 902, in the non-volatile memory 904, and/or on a removable non-transitory computer readable storage medium such as a CD or DVD.

From the foregoing, it will be appreciated that example systems, methods, and apparatus allow for use of third-party subscriber-level audience metrics that provide partial information on duration and unique audience sizes to overcome the anonymity of census-level impressions when estimating total unique audience sizes for media. In the examples disclosed herein, an audience metrics estimator determines census-level unique audience and durations across demographics by generating probability distributions and determining probability divergences that exist between the third-party census-level data and subscriber data and establishing a search space within bounds based on an equality constraint, such that the iteration over the search space until the equality constraint is satisfied yields census-level individual data estimates. The examples disclosed herein determine audience sizes and durations for different demographics at the census level using third-party-derived partial audience metrics and total census-level durations. The examples disclosed herein permit estimations that are logically consistent with all constraints, scale independence and invariance. Furthermore, the examples disclosed herein permit monitoring media impressions of any one or more media types.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus to determine census-level audience metrics across demographics, the apparatus comprising:
a distribution parameter solver to initialize distribution parameter values for a probability of an individual within a demographic being included in a subscriber audience for the demographic and having a first average impression duration, the subscriber audience having a first subscriber audience size;
a divergence parameter solver to determine divergence parameter values between (i) the subscriber audience size and the first impression duration and (ii) a census-level audience size and a second impression duration based on the initialized distribution parameter values;
a search space identifier to identify a search space within bounds based on a census-level total impression count and a census-level total impression duration, the search space to define a range including an equality constraint; and
an iterator to iterate over the search space until census-level outputs based on the divergence parameter values satisfy the equality constraint, the census-level outputs including census-level unique audience size and census-level impression duration for the demographic.

2. The apparatus of claim 1, further including a database to:
store, from a database proprietor, subscriber data including the first subscriber audience size and the first impression duration for the demographic;
access, from a user device, a user-based impression duration; and
store census-level data including the census-level total impression duration, the census-level total impression duration including the user-based impression duration.

3. The apparatus of claim 2, wherein the census-level audience metrics are media audience metrics, the media including at least one of a webpage, an advertisement, or a video.

4. The apparatus of claim 2, wherein the census-level data includes data logged by an audience measurement entity.

5. The apparatus of claim 2, wherein the divergence parameter solver is to determine the divergence parameter values based on a Kullback-Leibler probability divergence.

6. The apparatus of claim 2, wherein the equality constraint is valid for the census-level audience metrics across a plurality of demographics represented in the subscriber data.

7. The apparatus of claim 1, wherein the subscriber audience size is provided by a database proprietor.

8. A method to determine census-level audience metrics across demographics, the method comprising:
initializing distribution parameter values for a probability of an individual within a demographic being included in a subscriber audience for the demographic and having a first average impression duration, the subscriber audience having a first subscriber audience size;
determining, by executing an instruction with a processor, divergence parameter values between (i) the subscriber audience size and the first impression duration and (ii) a census-level audience size and a second impression duration based on the initialized distribution parameter values;
identifying a search space within bounds based on a census-level total impression count and a census-level total impression duration, the search space to define a range including an equality constraint; and
iterating, by executing an instruction with the processor, over the search space until census-level outputs based on the divergence parameter values satisfy the equality constraint, the census-level outputs including census-level unique audience size and census-level impression duration for the demographic.

9. The method of claim 8, further including:
storing, from a database proprietor, subscriber data including the first subscriber audience size and the first impression duration for the demographic;
accessing, from a user device, a user-based impression duration; and
storing census-level data including the census-level total impression duration, the census-level total impression duration including the user-based impression duration.

10. The method of claim 9, wherein the census-level audience metrics are media audience metrics, the media including at least one of a webpage, an advertisement, or a video.

11. The method of claim 9, wherein the census-level data includes data logged by an audience measurement entity.

12. The method of claim 9, further including determining the divergence parameter values based on a Kullback-Leibler probability divergence.

13. The method of claim 9, wherein the equality constraint is valid for the census-level audience metrics across a plurality of demographics represented in the subscriber data.

14. The method of claim 8, wherein the subscriber audience size is provided by a database proprietor.

15. A non-transitory computer readable storage medium comprising instructions that, when executed, cause a processor to at least:
initialize distribution parameter values for a probability of an individual within a demographic being included in a subscriber audience for the demographic and having a first average impression duration, the subscriber audience having a first subscriber audience size;
determine divergence parameter values between (i) the subscriber audience size and the first impression duration and (ii) a census-level audience size and a second impression duration based on the initialized distribution parameter values;
identify a search space within bounds based on a census-level total impression count and a census-level total impression duration, the search space to define a range including an equality constraint; and
iterate over the search space until census-level outputs based on the divergence parameter values satisfy the equality constraint, the census-level outputs including census-level unique audience size and census-level impression duration for the demographic.

16. The non-transitory computer readable storage medium of claim 15, wherein the instructions, when executed, cause a processor to:
store, from a database proprietor, subscriber data including the first subscriber audience size and the first impression duration for the demographic;
access, from a user device, a user-based impression duration; and
store census-level data including the census-level total impression duration, the census-level total impression duration including the user-based impression duration.

17. The non-transitory computer readable storage medium of claim 16, wherein the instructions, when executed, cause a processor to determine the divergence parameter values based on a Kullback-Leibler probability divergence.

18. The non-transitory computer readable storage medium of claim 16, wherein the instructions, when executed, cause a processor to verify the equality constraint is valid for the census-level audience metrics across a plurality of demographics represented in the subscriber data.

19. The non-transitory computer readable storage medium of claim 16, wherein the instructions, when executed, cause a processor to retrieve census-level data, the census-level data including data logged by an audience measurement entity.

20. The non-transitory computer readable storage medium of claim 15, wherein the instructions, when executed, cause a processor to retrieve the subscriber audience size from a database proprietor.
